(19) United States
(12) Patent Application Publication
(10) Pub. No.: US 2018/0070572 A1
(43) Pub. Date: Mar. 15, 2018

(54) Container Mountable On A Fishing Rod

(71) Applicants: Kenneth D. Lewis, St. George, UT (US); Jon Petty, St. George, UT (US)

(72) Inventors: Kenneth D. Lewis, St. George, UT (US); Jon Petty, St. George, UT (US)

(21) Appl. No.: 15/703,868

(22) Filed: Sep. 13, 2017

Related U.S. Application Data
(60) Provisional application No. 62/393,644, filed on Sep. 13, 2016.
(60) Provisional application No. 62/459,998, filed on Feb. 16, 2017.

(51) Int. Cl. A01K 97/06; A01K 87/00

(52) U.S. Cl. CPC A01K 97/06; A01K 87/00

(57) ABSTRACT

A container mountable on a fishing rod has a first cylinder and a second cylinder, wherein the second cylinder is at least partially received within the first cylinder and wherein there is a hook opening in each cylinder for receiving a fishing hook, lure, and/or bait. The second cylinder may further have a sidewall slot extending from the hook opening at least partially around the circumference of the second cylinder. The first cylinder may further have two securing arms configured to receive an elastic band for securing to a rod.

### CROSS-REFERENCE TO RELATED APPLICATIONS

This application claims the benefit of U.S. Provisional Application Ser. No. 62/393,644, filed on Sep. 13, 2016, and U.S. Provisional Application Ser. No. 62/459,998, filed on Feb. 16, 2017, both of which are incorporated herein by reference in their entireties.

### TECHNICAL FIELD

The present disclosure relates to fishing accessories. More particularly, the present disclosure relates to a container mountable on a fishing rod for storing hooks, bait, and other fishing items.

### BACKGROUND

Fishing is an extremely popular sport, with most people using a rod and reel. Many times, a fisherman will have one or more hooks, with or without bait, attached to the line on the rod. It is inconvenient to remove the hook, and can lead to tangles in a tackle box when a hook is removed and stored therein. Further, if the hook is baited, the bait would typically be removed before storing, which further complicates the process. If the hook is left on the line, the user risks inadvertently hooking an object or person, or tangling the line. To avoid those issues, a user may wrap the hook line around the rod, or secure the hook to the handle (which is often made of cork material, rubber, or foam). However, this not only requires removal of bait, it also adds to the risk of the user getting snagged in the hand by the hook, especially when using a hook with more than one hook (like a treble hook).

As such, strides have been made to solve the above problems. One such effort is U.S. Pat. No. 5,220,742 (the '742 patent) to Lewis (a common inventor of this application), which is incorporated by reference in its entirety. In the '742 patent, Lewis addressed several of the issues discussed above by creating a protective case that was mountable to a rod for storing fishing lures and hooks. However, despite that patent, several issues still remain. For example, the '742 patent is not effective in storing multiple lures on a line. In other words, a fisherman may have a line having two or more hooks/lures thereon. When seeking to store multiple hooks/lures using the '742 patent, it required a user to place them in the same container, with the fishing line exiting through the same fishing line opening in the housing. This creates tangles and, in some instances, unwanted combinations between baits/lures. As such, under the prior art, a user could only effectively use one hook/lure at a time on the rod. Further, the '742 patent fails to disclose a protective case/housing capable of receiving elongated fishing lures having multiple hooks. Accordingly, the prior art failed to solve the needs of the industry.

As such, there remains a need for a method and apparatus that allows a user to store more than one hook/lure therein without entangling lines or mixing baits. Other aspects of the current disclosure will also provide other benefits, such as ease of installation and removal, securing the hooks/lures in the container, and others.

### SUMMARY OF EXAMPLE EMBODIMENTS

In one embodiment, a container mountable on a fishing rod comprises a hollow first cylinder and a hollow second cylinder, wherein the second cylinder is at least partially received within the first cylinder and wherein there is a hook opening in each cylinder for receiving a fishing hook, lure, and/or bait. In one embodiment, the second cylinder comprises a sidewall slot extending from the hook opening. In one embodiment, the first cylinder comprises two securing arms configured to receive an elastic band for securing to a rod. In another embodiment, the first cylinder comprises at least three securing arms, wherein two of the securing arms are in close proximity such that an elastic band may be secured therebetween for storage.

In one embodiment, a container mountable on a fishing rod comprises a first cylinder and a second cylinder, wherein the second cylinder has a plurality of sidewall slots and wherein the first and second cylinders are sufficiently elongated so as to store a multi-hook lure.

In one embodiment, a container mountable on a fishing rod comprises a rectangular housing having a hook opening and a lid for covering the hook opening. The lid may have one or more apertures therein for receiving fishing lines or hooks. The lid may further be coupled to the housing in a number of ways, such as tongue and groove, hinged, pivot screw, etc.

In one embodiment, a system for storing multiple hooks, lures, or baits comprises a plurality of rod-mountable containers, wherein each container comprises an outer cylinder and an inner cylinder; the inner cylinder being at least partially received in the outer cylinder and configured to rotate therein. The outer and inner cylinders having a hook opening in the sidewall thereof so as to receive the hooks, lures, or bait. The inner cylinder further comprising a slot for securing the hooks or lures. The outer cylinder comprising a means for attaching the plurality of rod-mountable containers to a fishing rod.

### BRIEF DESCRIPTION OF THE DRAWINGS

FIG. 1 is a perspective view of a container mountable on a fishing rod;

FIG. 2 is a perspective view of a container mountable on a fishing rod with the first and second cylinders separated;

FIG. 3 is a side elevation view of a container mountable on a fishing rod with the first and second cylinders separated;

FIG. 4 is a side elevation view of a container mountable on a fishing rod with the first and second cylinders separated with the receiving slot visible in the sidewall of the second cylinder;

FIG. 5 is a top plan view of a container mountable on a fishing rod with the first and second cylinders separated;

FIG. 6 is an end view of the cylinders of a container mountable on a fishing rod;

FIG. 7 is a bottom view of the cylinders of a container mountable on a fishing rod;

FIG. 8 is a perspective view of a container mountable on a fishing rod, mounted on a fishing rod;

FIG. 9 is a top view illustrating a fishing hook in a container mountable on a fishing rod;

FIG. 10 is a top view illustrating the second cylinder partially rotated within the first cylinder of a container mountable on a fishing rod, partially enclosing the fishing hook;

FIG. 11 is a top view illustrating the second cylinder fully-rotated within the first cylinder, thereby enclosing the hook within the container mountable on a fishing rod;

FIG. 12 is a top view of a container mountable on a fishing rod comprising a plurality of securing arms;

FIG. 13 is a perspective view of a container mountable on a fishing rod comprising a plurality of securing arms in close proximity to one another;

FIG. 14 is a top view of a container mountable on a fishing rod comprising a plurality of securing arms in close proximity to one another;

FIG. 15 is a top perspective view of a container mountable on a fishing rod with a pivotable lid;

FIG. 16 is a perspective view of a container mountable on a fishing rod with a slidable lid;

FIG. 17 is a perspective view of two containers mountable on a fishing rod for securing a lure having two hooks;

FIG. 18 is an elongated container mountable on a fishing rod with a plurality of sidewall slots on the second container;

FIG. 19 is a perspective view of a second cylinder of a container mountable on a fishing rod, the second cylinder comprising a plurality of sidewall slots;

FIG. 20 is a perspective view of a container mountable on a fishing rod, the container comprising a plurality of separated chambers; and

FIG. 21 is a top plan view of a container mountable on a fishing rod, the container comprising a plurality of separated chambers.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various different sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

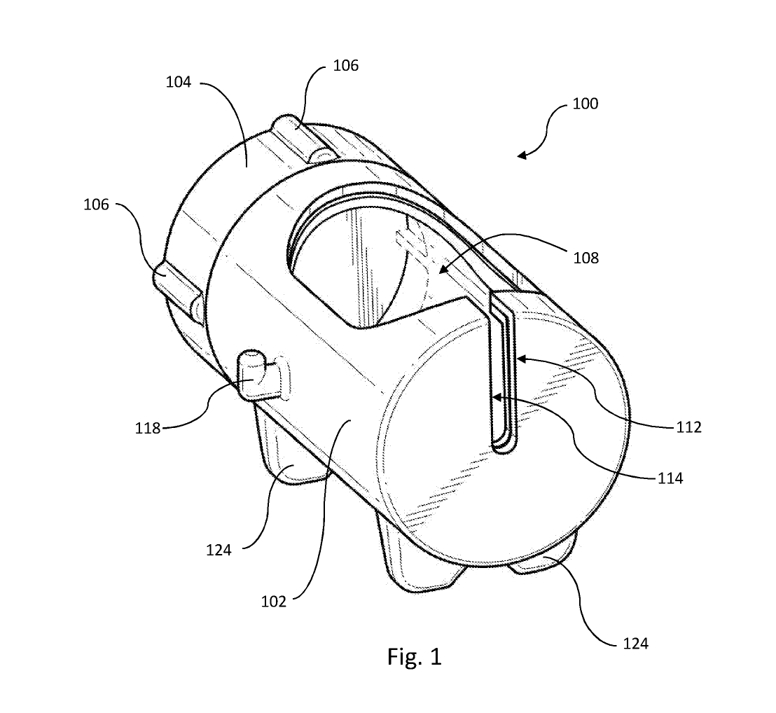

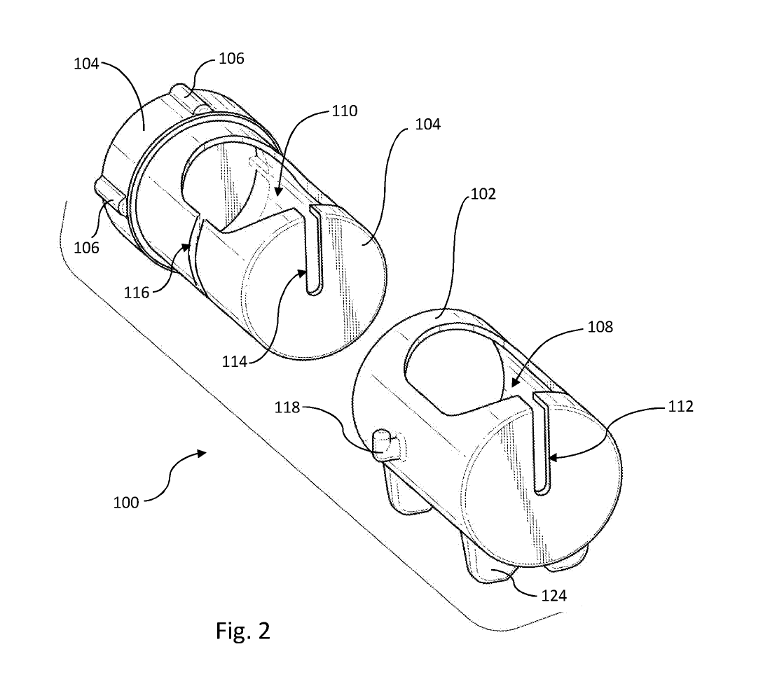

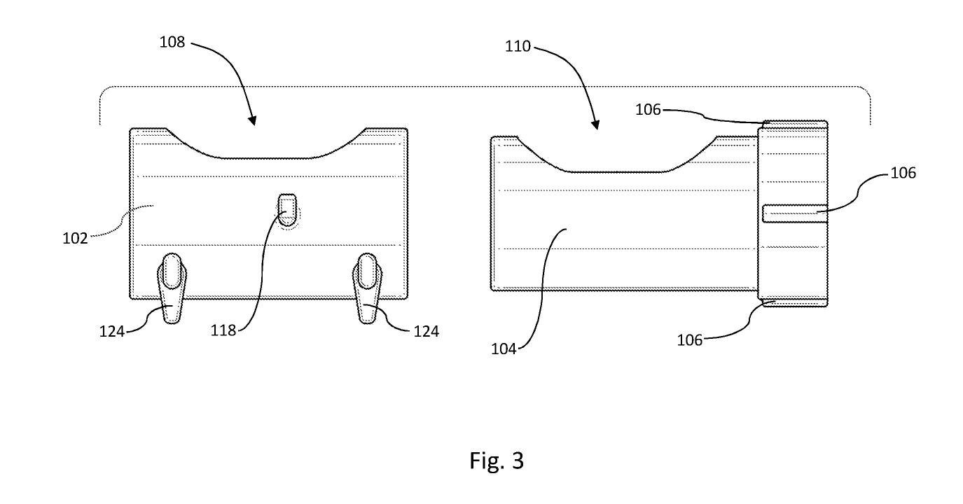

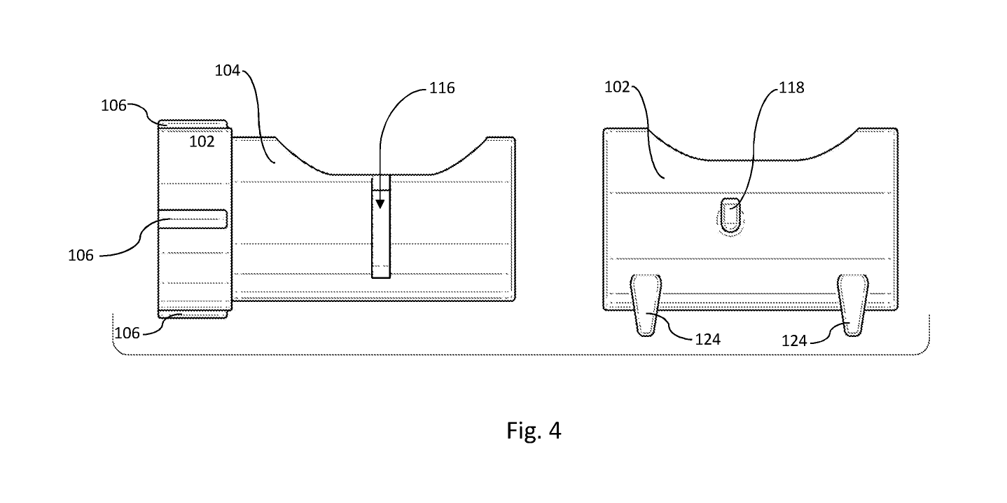

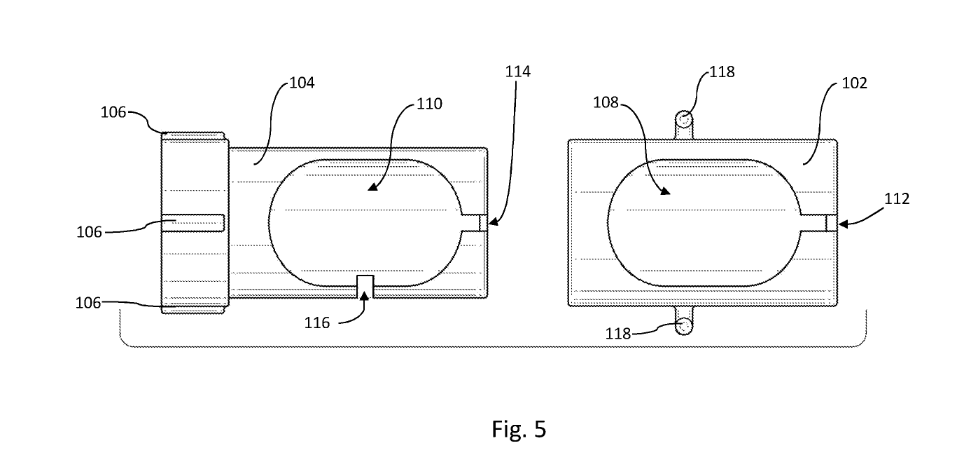

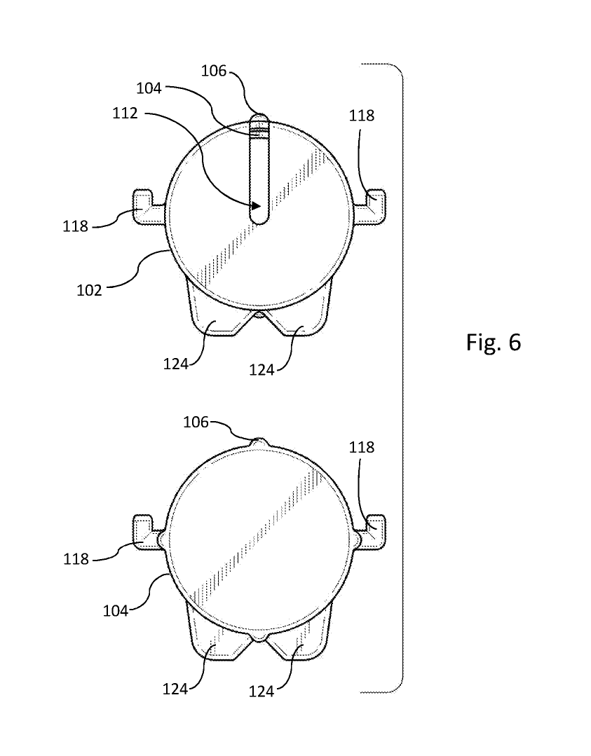

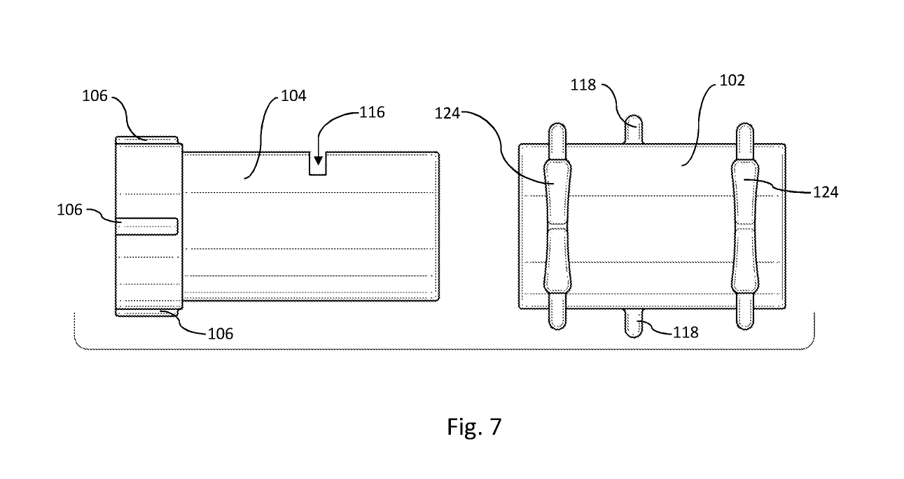

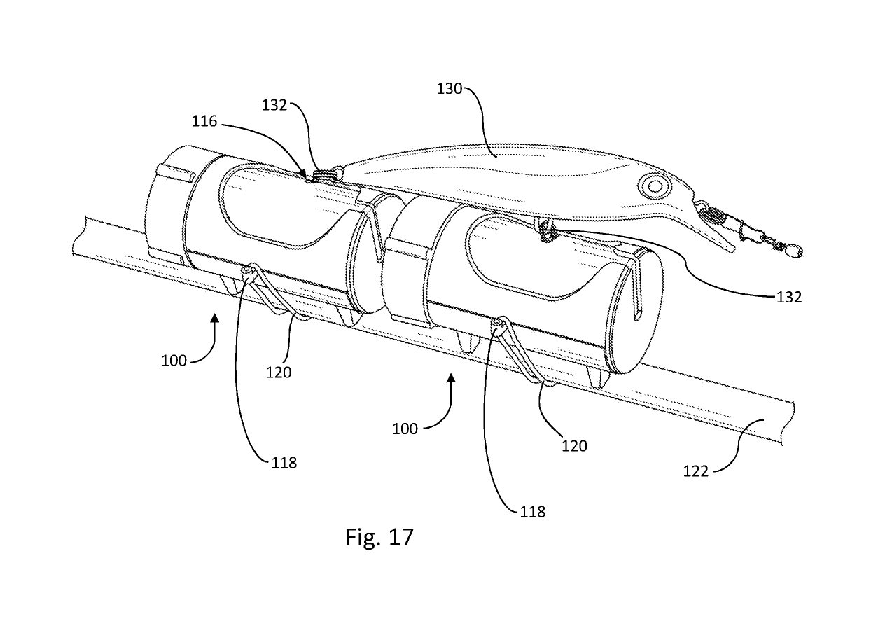

In one embodiment, as generally shown in FIGS. 1-11, a container mountable on a fishing rod 100 comprises a hollow first cylinder 102 and a hollow second cylinder 104, wherein the second cylinder 104 is at least partially received within the first cylinder 102. In other words, the fist cylinder 102 is open on a first end so as to receive the second cylinder 104 therethrough. The second cylinder 104 is sized so as to be rotatable within the first cylinder 102, with the sidewalls of the first and second cylinders 102, 104 being proximal to one another so as to remain in place due to friction and tension, but remaining rotatable when a user exerts a rotating force thereon. FIG. 1 illustrates the second cylinder 104 fully-inserted into the first cylinder 102, wherein an end of the second cylinder 104 remains exposed and has one or more gripping protrusions 106 thereon. Each cylinder 102, 104 comprises a hook opening 108, 110 in the sidewall for receiving a fishing hook, lure, and/or bait therein. Each cylinder further comprises an end slot 112, 114 in an end thereof for receiving fishing line. In other words, the second cylinder 104 is inserted into the first cylinder 102 on a first end, with the end slots 112, 114 aligning on a second end. In such a manner, a hook, lure, or bait on a line may be inserted into the container mountable on a fishing rod 100, with the fishing line passing through the end slots 112, 114 respectively. In one embodiment, the second cylinder 104 comprises a sidewall slot 116 extending from the hook opening 110 and extending at least partially around the circumference of the sidewall of the second cylinder 104. For example, a major limitation in the prior art is the ability to use a container for storing lures. Lures can come in varying sizes, making it difficult to use a compact container for storage. For example, a fisherman utilizing the device of the '742 patent would only have been able to contain small lures. A large lure, or multiple hook lure, would not have been able to be contained using the '742 patent or others in the prior art. The container mountable on a fishing rod 100 solves that problem by having sidewall slot 116. The sidewall slot 116 allows the lure to remain on the outside of the container (if too large to fit inside), while allowing the hook(s) to be safely secured using the sidewall slots 116. And further, as shown in FIG. 17, a lure having multiple hooks can be stored using a plurality of containers mountable on a fishing rod 100. In one embodiment, the first cylinder 102 comprises two securing arms 118 extending from the sidewall, each on an opposite side of the first cylinder 102, configured to receive an elastic band 120 for securing to a rod. Each securing arm 118 may extend substantially perpendicular to the sidewall of the first cylinder 102, with the distal end bent upward (e.g., an elbow bend) so as to prohibit an elastic band from accidentally being removed therefrom.

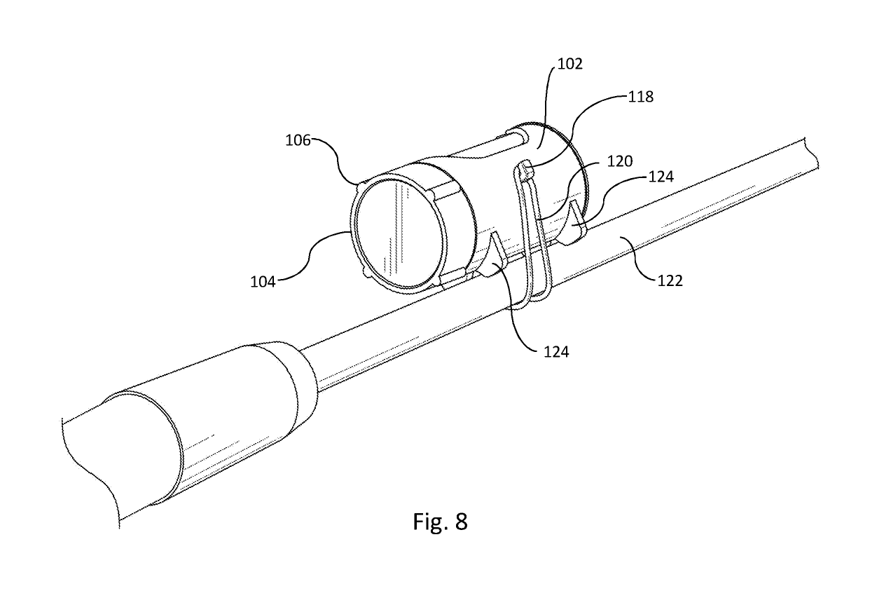

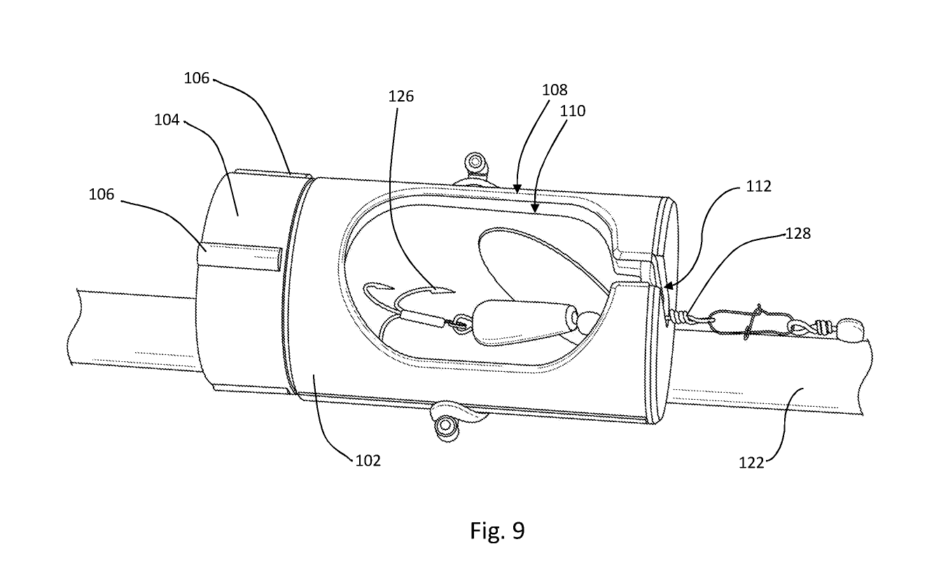

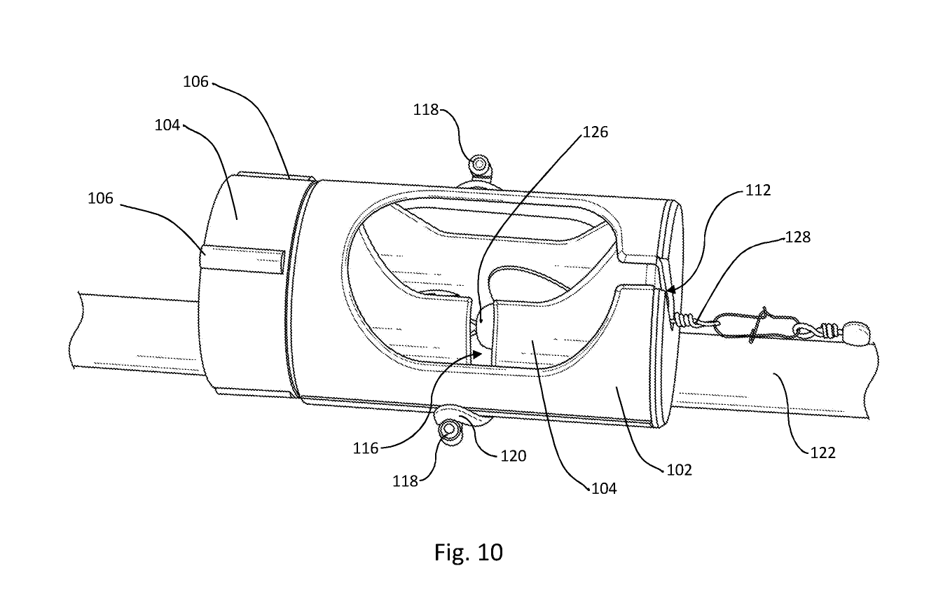

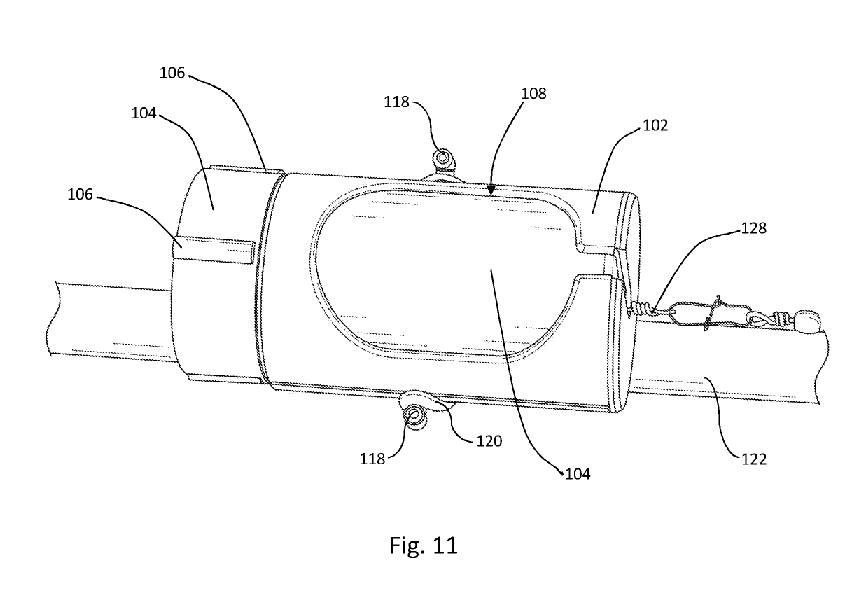

In one non-limiting example of use, as best seen in FIG. 8, a user would place the container mountable on a fishing rod 100 on a fishing rod 122, the rod 122 being received between legs 124 of the first cylinder 102. A user would then secure an elastic band 120 to a first securing arm 118, extend it around the fishing rod 122, and secure it to the second securing arm 118 on the opposite side. The second cylinder 104 is easily rotatable within the first cylinder 102, especially using gripping protrusions 106. A user may then rotate the second cylinder 104 within the first cylinder 102 to align the hook openings 108, 110. Referring now to FIGS. 9-11, with the hook openings 108, 110 aligned, a user may insert a hook 126, with the line 128 passing through end slots 112, 114. A user may then rotate the second cylinder 104 within the first cylinder 102, FIG. 10 illustrates the second cylinder 104 partially rotated within the first cylinder 102, until the second hook opening 110 is fully enclosed by the sidewalls of the first cylinder 102 (FIG. 11). In another example, as best shown in FIG. 17, the user may place a hook of a lure 130 into the hook openings 108, 110 with the hook coupling portion 132 passing through sidewall slot 116 of one or more containers mountable on a fishing rod 100. Again, the user would twist/rotate the second cylinder 104 within the first cylinder 102 until the hook opening 110 in the second cylinder 104 is not accessible and the hook coupling portion 132 is interposed between the sidewall of the first cylinder 102 and the end of the sidewall slot 116 of the second cylinder 104, as shown in FIG. 17.

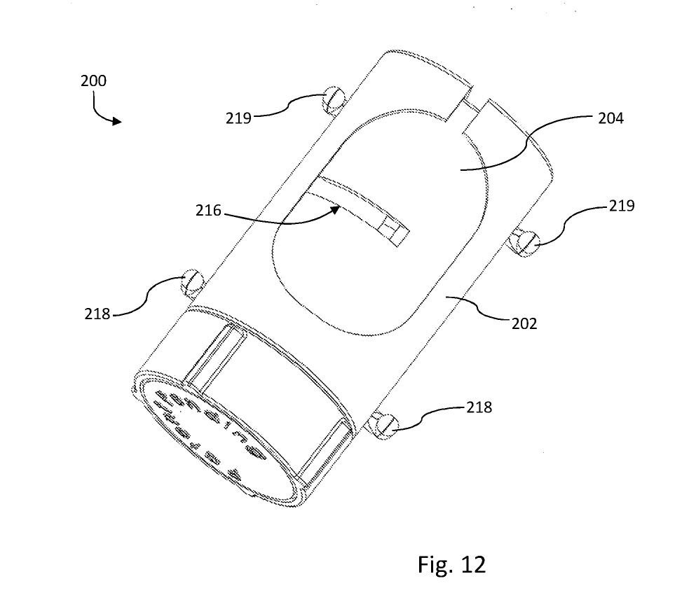

Referring now to FIG. 12, in one embodiment, a container mountable to a fishing rod 200 comprises a first cylinder 202 having a first set of securing arms 218 on a first end and a second set of securing arms 219 on a second end. This allows the container mountable to a fishing rod 200 to be more securely coupled to a fishing rod. Like the first embodiment, this embodiment comprises equivalent components, including the sidewall slot 216.

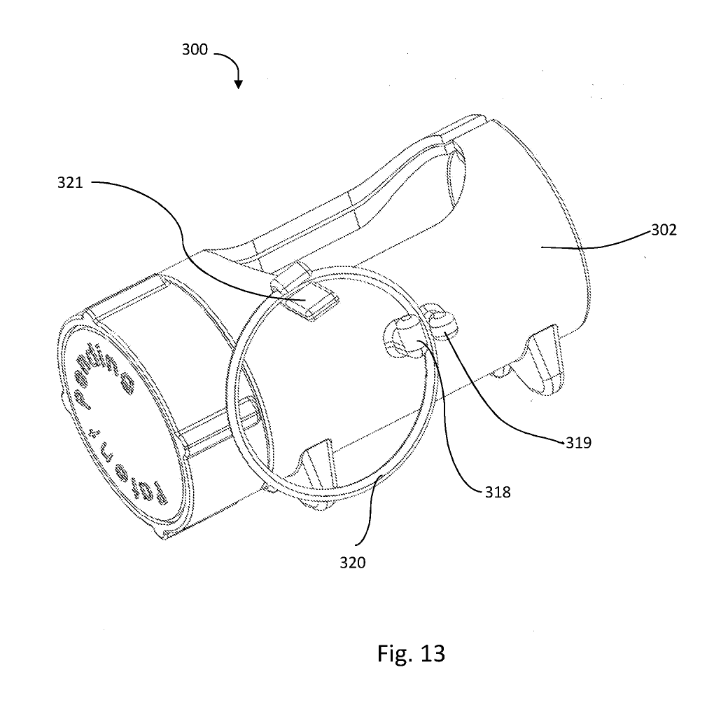

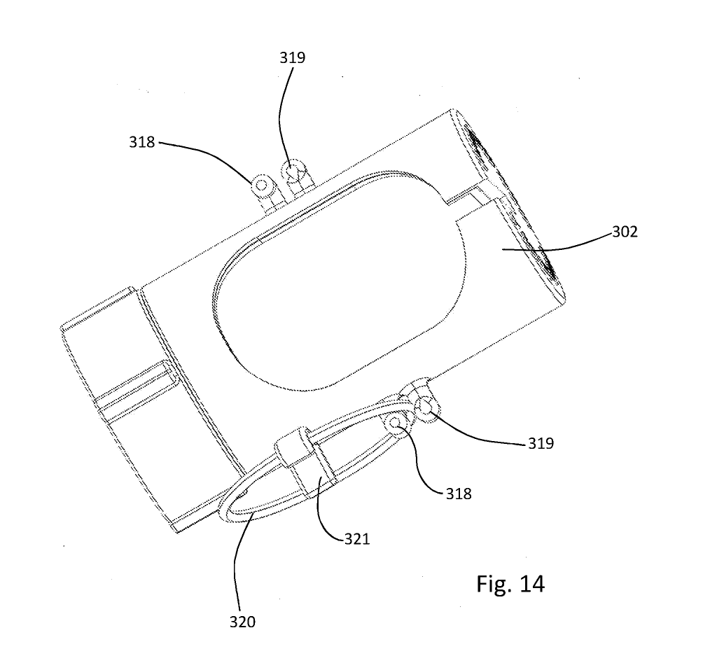

In another embodiment, as best seen in FIGS. 13-14, a container mountable to a fishing rod 300 comprises a first cylinder 302 having a first set of securing arms 318 in close proximity to a second set of securing arms 319 such that an elastic band 320 may be interposed and secured therebetween, via tension, for storage. In other words, when not mounted to a fishing rod, the elastic band 320 may become lost when not secured to the opposite securing arm. Therefore, to reduce the risk of losing the elastic band 320, it is secured between a set of securing arms 118, 119. While four securing arms 318, 319 are shown (two on each side of the first cylinder 302), it will be appreciated that only three are required for storing the elastic band 320 in this example. In other words, a securing arm 318 and 319 on a first side, with only a securing arm 318 on the opposite side of the second cylinder 302.

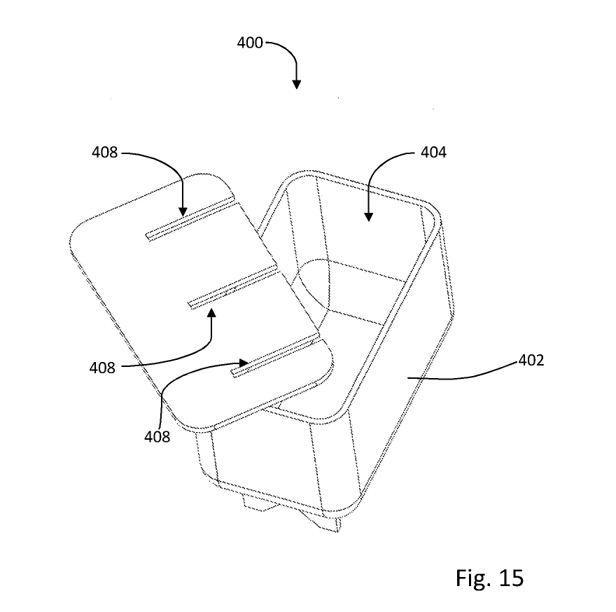

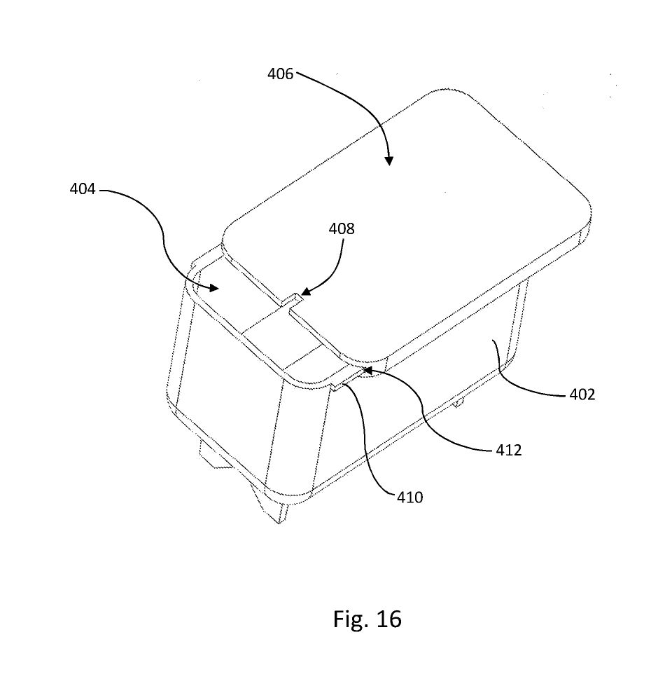

Referring to FIGS. 15-16, in one embodiment, a container mountable on a fishing rod 400 comprises a rectangular housing 402 having a hook opening 404 on a first side and a lid 406 for covering the hook opening 404. The lid 406 may have one or more apertures (e.g., slots) 408 therein for receiving fishing lines or hooks. The lid 406 may further be coupled to the housing 402 in a number of ways, such as tongue 410 and groove 412 (FIG. 16), hinged, pivot screw, locking tabs, etc.

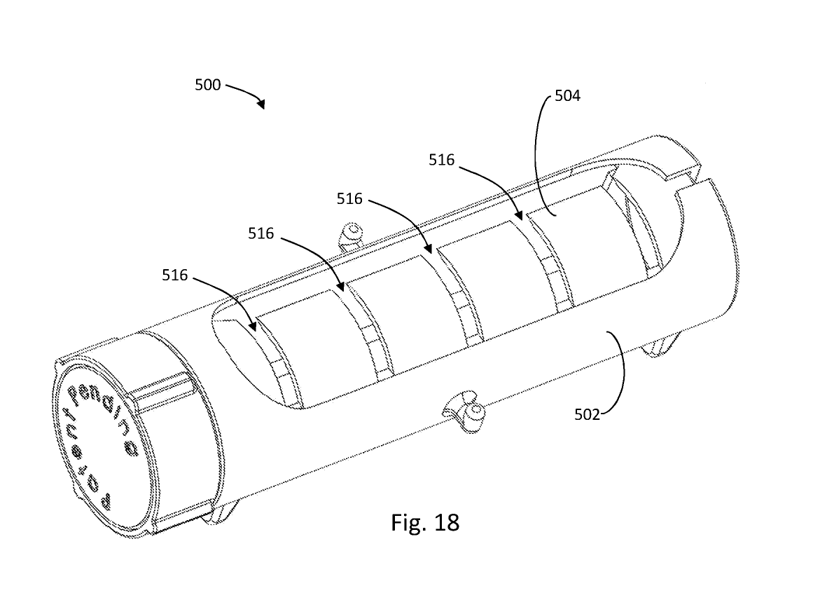

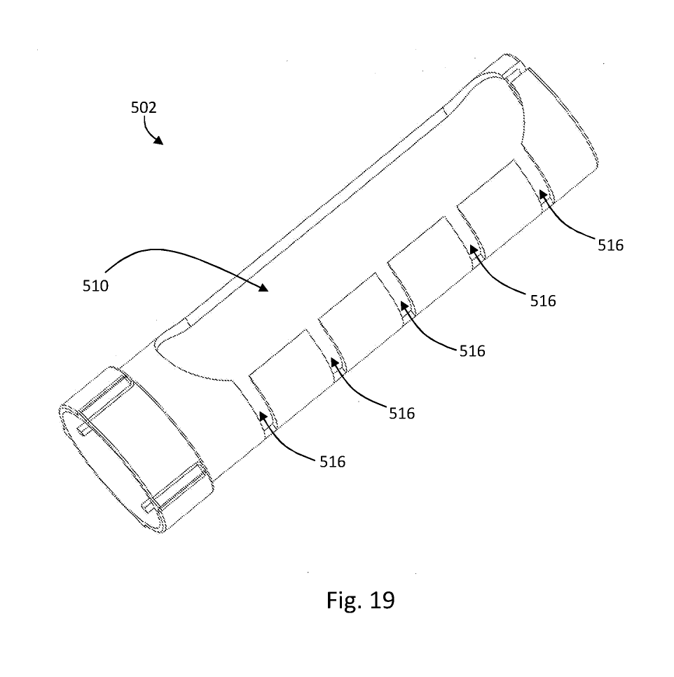

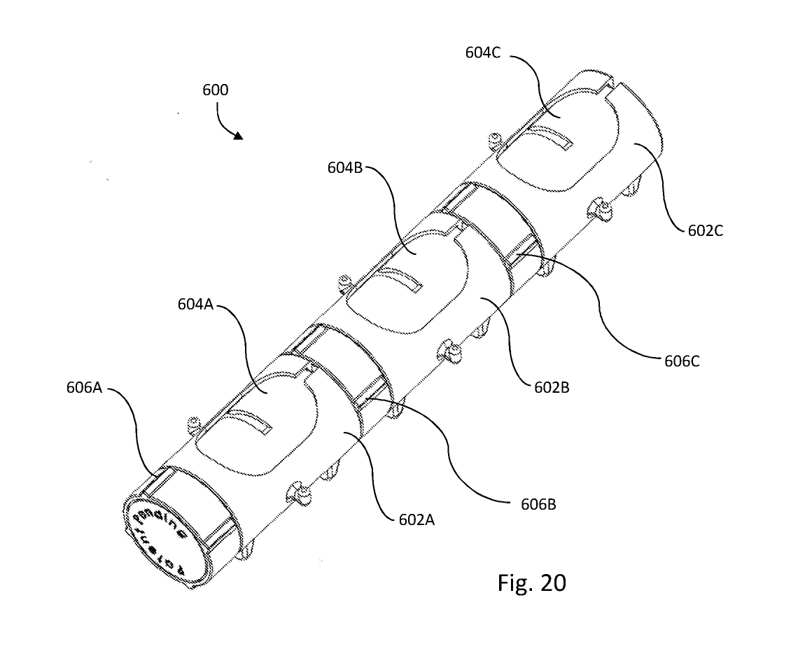

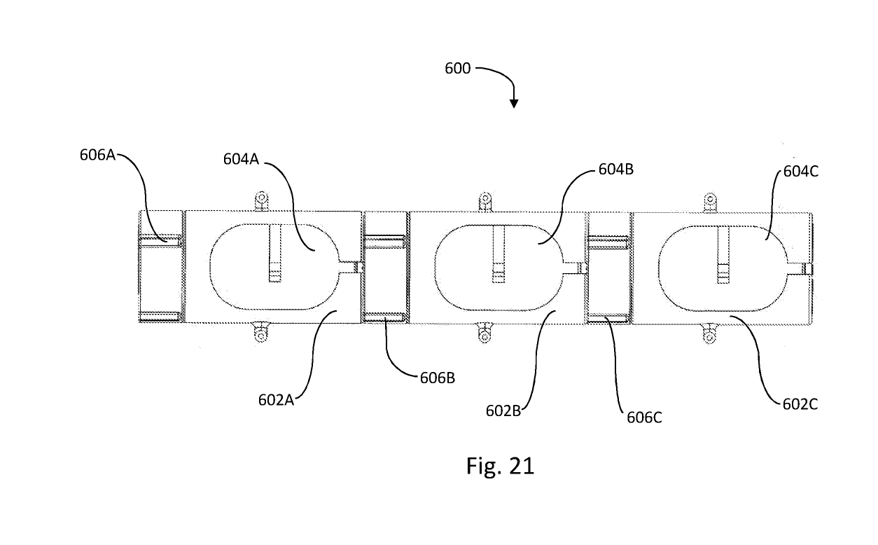

In one embodiment, as generally shown in FIGS. 18-19, a container mountable on a fishing rod 500 comprises a first cylinder 502 and a second cylinder 504, wherein the second cylinder 504 has a plurality of sidewall slots 516 and wherein the first and second cylinders 502, 504 are sufficiently elongated so as to store a multi-hook lure. For example, as opposed to using the two containers mountable on a fishing rod 100 of FIG. 17 to store a lure having multiple hooks, a user may use a single elongated container mountable on a fishing rod 500 for storing a lure with multiple hooks. The plurality of sidewall slots 516 allow for numerous lengths and spans of hooks to be stored therein. The elongated container mountable on a fishing rod 500 works well for a lure, where separate compartments are not needed to separate baits, etc. However, should a user desire to use multiple hooks and baits, keeping them separate when stored can be beneficial. Accordingly, FIGS. 20-21 illustrate a container mountable on a fishing rod 600 comprising a plurality of first cylinders 602A, 602B, 602C and a plurality of second cylinders 604A, 604B, 604C. The second cylinders 604A-C are independently rotatable using the exposed ends of each second cylinder 604A-C and gripping protrusions 606A-C, respectively.

In one embodiment, as best shown in FIG. 17, a system for storing multiple hooks, lures, or baits comprises a plurality of rod-mountable containers 100 wherein each container 100 comprises an outer cylinder 102 (the first cylinder) and an inner cylinder 104 (the second cylinder); the inner cylinder 104 being at least partially received in the outer cylinder 102 and configured to rotate therein. The outer and inner cylinders 102, 104 having a hook opening 108, 110 in the sidewall thereof so as to receive the hooks, lures, or bait. The inner cylinder 104 further comprising a sidewall slot 116 for securing the hooks or lures. The outer cylinder 102 comprising a means for attaching the plurality of rod-mountable containers 100 to a fishing rod, such as securing arms 118, but may also include clamps, hooks and loops (e.g., Velcro®), or other attachment means.

In one embodiment, a container mountable on a fishing rod may comprise foam, felt, or other material on the inside of the container to prevent bait from drying out or to aid with strike attractant (scents); the outer or inner cylinder may have a magnet therein so as to secure the hook on the inside thereof more easily; a clear window may be added to the inner cylinder, such that when the hook opening has been rotated to secure bait, the window would allow a user to be able to see into the chamber to identify the bait within the cylinder without needing to open it. In one embodiment, the inner cylinder is transparent, allowing a user to see into the enclosed chamber regardless of position. In one embodiment, when storing bait and/or using as a scent chamber, it may be beneficial to close all openings. As such, a plug may be used in connection with the line receiving slot, and is particularly beneficial where the slot remains open when the inner cylinder is rotated within the outer cylinder to secure the contents; a pull-tab 321 (FIG. 14) coupled to an elastic band may have a plug thereon, so as to achieve a dual purpose—allowing a user to grip the elastic band and to also plug a slot (end slot or sidewall slot). In yet another embodiment, LEDs or other lighting sources may be added, so as to illuminate the chambers for night fishing. This may be achieved by a replaceable end cap (e.g., such as the end-cap being undercut and being received within the cylinder and “snapped” into place). In another embodiment, a clip (not shown) may also be added so that when a hook is stored, the leader line may be wound and secured by the clip, so as to remain untangled.

It will be appreciated that while the container mountable to a fishing rod disclosed herein is removably attachable to the rod, such feature is not a requirement. In other words, the container may be permanently mounted to the rod or handle, either by the manufacturer or the consumer. Further, a user may opt to place the container in a pocket for transportation, rather than mount it on the pole.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein.

What is claimed is:

1. A container mountable on a fishing rod, comprising:
a first cylinder comprising a first securing arm opposite a second securing arm, one or more legs for coupling to a fishing rod, a hook opening, and an end slot; and
a second cylinder configured to be received within the first cylinder, the second cylinder comprising a hook opening, an end slot, and at least one sidewall slot extending from the hook opening and continuing at least partially around the circumference of the sidewall of the second cylinder;
wherein the second cylinder is rotatable within the first cylinder.

2. The container mountable on a fishing rod of claim 1, further comprising a plurality of securing arms in close proximity so as to exert tension on an elastic band.

3. The container mountable on a fishing rod of claim 1, further comprising gripping protrusions on the second cylinder.

4. The container mountable on a fishing rod of claim 1, wherein the first and second cylinders are configured to receive multi-hook lures by being elongated and by the second cylinder comprising a plurality of sidewall slots.

5. The container mountable on a fishing rod of claim 1, further comprising one or more magnets within the sidewalls of at least the first or second cylinder.

6. The container mountable on a fishing rod of claim 1, further comprising foam or felt within the first or second cylinder.

7. A container mountable on a fishing rod, comprising:
a housing having a plurality of securing arms;
a lid having one or more slots therein; and
legs for engaging a fishing rod.

8. The container mountable on a fishing rod of claim 7, wherein the lid is hingedly attached to the housing.

9. The container mountable on a fishing rod of claim 7, wherein the lid is slidably attached to the housing.

10. The container mountable on a fishing rod of claim 7, further comprising an elastic band for securing to the securing arms of the housing.

11. A container mountable on a fishing rod, comprising:
a plurality of first cylinders, wherein each first cylinder comprises a plurality of securing arms, a hook opening, and an end slot;
a plurality of second cylinders, wherein each second cylinder is configured to be independently rotatable within the plurality of first cylinders, each second cylinder comprising a hook opening, an end slot, and at least one sidewall slot; and
one or more legs extending from one or more first cylinders.

12. A method of using a container mountable on a fishing rod, the method comprising:
coupling a container to a fishing rod;
placing a lure hook in the hook opening of the container; and
rotating a second cylinder of the container to secure the lure hook;
a hook coupling portion extending through the sidewall slot of the second cylinder.

13. The method of claim 12, further comprising the steps of:
coupling a second container to the fishing rod;
placing a lure hook in the hook opening of the second container;
rotating a second cylinder of the second container to secure the lure hook;
a hook coupling portion extending through the sidewall slot of the second cylinder of the second container.

14. The method of claim 13, wherein a user places the first lure hook in the first container and the second lure hook in the second container.
